(19) United States
(12) Patent Application Publication
(10) Pub. No.: US 2026/0302743 A1
(43) Pub. Date: Oct. 1, 2026

(54) CONFIGURABLE CABLE TRAY LINERS AND CABLE TRAY SYSTEMS HAVING CONFIGURABLE CABLE TRAY LINERS

(71) Applicant: ILLINOIS TOOL WORKS INC., Glenview, IL (US)

(72) Inventor: Peng Li, Palatine, IL (US)

(21) Appl. No.: 19/568,121

(22) Filed: Mar. 16, 2026

Related U.S. Application Data
(60) Provisional application No. 63/779,742, filed on Mar. 28, 2025.

(51) Int. Cl. H02G 3/04

(52) U.S. Cl. CPC H02G 3/0456

(57) ABSTRACT

This disclosure relates generally to networking cable tray systems, and more particularly, to configurable cable tray liners and cable tray systems having configurable cable tray liners. The configurable cable tray liners disclosed herein have combinations of perforated lines, which can be torn or folded, alone or in combination, to line a variety of different cable trays.

### FIELD OF THE DISCLOSURE

The present application claims the benefit of U.S. Provisional Patent Application Ser. No. 63/779,742, filed Mar. 28, 2025, entitled “CONFIGURABLE CABLE TRAY LINERS AND CABLE TRAY SYSTEMS HAVING CONFIGURABLE CABLE TRAY LINERS.” The entirety of U.S. Provisional Patent Application Ser. No. 63/779,742 is expressly incorporated herein by reference.

### FIELD OF THE DISCLOSURE

This disclosure relates generally to networking cable tray systems, and more particularly, to configurable cable tray liners and cable tray systems having configurable cable tray liners.

### BACKGROUND

Cable trays are rigid, open track systems designed to securely support and organize insulated electrical cables, wires, and other electrical components used for power distribution, control, and communication in buildings and industrial settings. In this capacity, cable trays come in a variety of dimensions, making efficient lining of these trays challenging.

### SUMMARY

Configurable cable tray liners and cable tray systems having configurable cable tray liners are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an example of a cable tray having a cable tray liner configured from a cable tray liner having multiple configurations, in accordance with aspects of this disclosure.

FIG. 2 illustrates an example configurable cable tray liner in accordance with aspects of this disclosure.

FIG. 3 is another example configurable cable tray liner in accordance with aspects of this disclosure.

FIG. 4 is another example implementation of the configurable cable tray liner in accordance with aspects of this disclosure.

FIG. 5 is another example implementation of the configurable cable tray liner in accordance with aspects of this disclosure.

FIG. 6 illustrates an example process of configuring the cable tray liner from an unconfigured form to a configured form for installation in the example cable tray of FIG. 1.

FIG. 7 illustrates an example guide system for reconfiguring the cable tray liner of FIG. 3.

FIG. 8 illustrates an example guide system for reconfiguring the cable tray liner of FIG. 4.

The figures are not necessarily to scale. Where appropriate, similar or identical reference numbers are used to refer to similar or identical components.

### DETAILED DESCRIPTION

According to aspects of this disclosure, a cable tray system includes a cable tray and a cable tray liner. In this aspect, the cable tray includes a carrying base, wherein the carrying base includes: a central longitudinal axis; a first side parallel to the central longitudinal axis; a second side opposite the first side and parallel to the central longitudinal axis; a width perpendicular to the central longitudinal axis and defined by the distance between the first side and the second side; and a length coaxial to the central longitudinal axis. In some examples, the cable tray may further include side walls or side rails which rise perpendicular from both the first and second sides of the carrying base.

In a further aspect, the cable tray carrying base has a width which is perpendicular to the central longitudinal axis of the carrying base, and which is defined by the distance between the first side and the second side of the carrying base. In some examples, the cable tray carrying base has a width which is from 6 inches to 42 inches, from 12 inches to 36 inches, or from 12 to 24 inches. In some examples, the configurable cable tray liner has a width which is from 10 inches to 54 inches. In some examples, the configurable cable tray liner has a width which is 24 inches or 36 inches.

In this aspect, the cable tray liner includes: a central longitudinal axis; a first side edge parallel to the central longitudinal axis; a second side edge opposite the first side edge and parallel to the central longitudinal axis; a first set of one or more perforated lines positioned between the central longitudinal axis and the first side edge, wherein the first set of perforated lines are parallel to the first side edge; and a second set of two or more perforated lines positioned between the central longitudinal axis and the second side edge, wherein the second set of perforated lines are parallel to the second side edge; and wherein the first and second sets of perforated lines extend along a full length of the cable tray liner. The cable tray liner may further include a central perforated line extending along the central longitudinal axis, wherein the central perforated line is parallel to the first and second side edges, and extends the full length of the cable tray liner.

The first set of one or more perforated lines may be positioned at any regular or irregular interval from the first side edge. Likewise, the second set of two or more perforated lines may be positioned at any regular or irregular interval from the second side edge. In some examples, the first set of perforated lines include perforated lines positioned at intervals or multiples of 2 inches from the first side edge. Likewise, the second set of perforated lines include perforated lines positioned at intervals or multiples of 2 inches from the second side edge. In some examples, the first set of perforated lines include three perforated lines positioned 2 inches, 4 inches, and 6 inches from the first side edge, and the second set of perforated lines include three perforated lines positioned 2 inches, 4 inches, and 6 inches from the second side edge. In some examples, the first set of perforated lines include four perforated lines positioned 2 inches, 4 inches, 6 inches, and 10 inches from the first side edge, and the second set of perforated lines include four perforated lines positioned 2 inches, 4 inches, 6 inches, and 10 inches from the second side edge.

The cable tray liners disclosed herein may further include one or more horizontal perforated lines, which are perpendicular to the central longitudinal axis of the cable tray liner, and which extend the full width of the cable tray liner. Horizontal perforated lines may be position at regular intervals along the length of the cable tray. In one example, multiple horizontal perforated lines are equally spaced apart along the length of the cable tray liner. In this example, horizontal perforated lines may be spaced from 1 to 3 feet apart, from 1 to 5 feet apart, from 1 to 10 feet apart, or greater than 10 feet apart, along the full length of the cable tray liner.

In another aspect, the perforated lines disclosed herein, including the first set of perforated lines, the second set of perforated lines, any central perforated line, and any horizontal perforated lines, are foldable, tearable, or both. As discussed in greater detail below, folding or tearing of the first and second set of perforated lines, as well as any central perforated lines, serve to reconfigure the cable tray liner to facilitate lining a variety of different cable trays.

In a further aspect, the cable tray liners disclosed herein may be provided in the form of a roll or sheet. Horizontal perforated lines may be provided at regular intervals along the full length of the roll or sheet, to allow the necessary length of liner to be torn away.

The cable tray liners disclosed herein also have a thickness. For example, cable tray liner disclosed herein may have a thickness of from 5 to 40 thousandths of an inch (mils), from 10 to 30 mils, from 10 to 20 mils, 10 mils, 15 mils, 17 mils, or 30 mils.

In another aspect, the cable tray liner can be a reconfigured cable tray liner. In this aspect, the cable tray liner is reconfigured to be loaded into the cable tray, having dimensions aligned with the cable tray. In this aspect, the perforated lines disclosed herein, including the first set of perforated lines, the second set of perforated lines, any central perforated line, and any horizontal perforated lines, are folded, torn, or left unaltered.

In some examples, a cable tray system includes a cable tray and a cable tray liner, wherein the cable tray liner includes: a central longitudinal axis; a first side edge parallel to the central longitudinal axis; a second side edge opposite the first side edge and parallel to the central longitudinal axis; a width perpendicular to the central longitudinal axis and defined by the distance between the first side edge and the second side edge; a central perforated line extending along the central longitudinal axis along the full length of the liner; a first set of perforated lines having three perforated lines positioned 2 inches, 4 inches, and 6 inches from the first side edge; a second set of perforated lines having three perforated lines positioned 2 inches, 4 inches, and 6 inches from the second side edge; wherein the first and second sets of perforated lines extend along a full length of the liner; wherein the width is 24 inches; and wherein the central perforated line is equidistant from the first and second side edges (i.e., 12 inches from the first side edge and 12 inches from the second side edge).

This example cable tray liner can be reconfigured to be loaded into any number of different cable trays. In this aspect, the perforated lines, including the first set of perforated lines, the second set of perforated lines, and the central perforated line, are folded, torn, or left unaltered to match the dimensions of the specific cable tray. For example, if a cable tray has a width of 12 inches and no side walls, the cable tray liner is reconfigured to line the cable tray by tearing the central perforated line.

If the cable tray has, for example, a width of 12 inches and two side walls each having a height of 2 inches, the cable tray liner is reconfigured to line the cable tray by tearing the perforated line positioned 4 inches from the first side edge, tearing the perforated line positioned 4 inches from the second side edge, folding the perforated line positioned 6 inches from the first side edge, and folding the perforated line positioned 6 inches from the second side edge.

If the cable tray has, for example, a width of 12 inches and two side walls each having a height of 4 inches, the cable tray liner is reconfigured to line the cable tray by tearing the perforated line positioned 2 inches from the first side edge, tearing the perforated line positioned 2 inches from the second side edge, folding the perforated line positioned 6 inches from the first side edge, and folding the perforated line positioned 6 inches from the second side edge.

If the cable tray has, for example, a width of 12 inches and two side walls each having a height of 6 inches, the cable tray liner is reconfigured to line the cable tray by folding the perforated line positioned 6 inches from the first side edge, and folding the perforated line positioned 6 inches from the second side edge.

If the cable tray has, for example, a width of 16 inches and no side walls, the cable tray liner is reconfigured to line the cable tray by tearing the perforated line positioned 4 inches from the first side edge, and tearing the perforated line positioned 4 inches from the second side edge.

If the cable tray has, for example, a width of 16 inches and two side walls each having a height of 2 inches, the cable tray liner can be reconfigured to line the cable tray by tearing the perforated line positioned 2 inches from the first side edge, tearing the perforated line positioned 2 inches from the second side edge, folding the perforated line positioned 4 inches from the first side edge, and folding the perforated line positioned 4 inches from the second side edge.

If the cable tray has, for example, a width of 16 inches and two side walls each having a height of 4 inches, the cable tray liner is reconfigured to line the cable tray by folding the perforated line positioned 4 inches from the first side edge, and folding the perforated line positioned 4 inches from the second side edge.

In yet another example, there is provided a cable tray system having a cable tray and a cable tray liner, wherein the cable tray liner includes: a central longitudinal axis; a first side edge parallel to the central longitudinal axis; a second side edge opposite the first side edge and parallel to the central longitudinal axis; a width perpendicular to the central longitudinal axis and defined by the distance between the first side edge and the second side edge; a first set of perforated lines having four perforated lines positioned 2 inches, 4 inches, 6 inches, and 10 inches from the first side edge; a second set of perforated lines having four perforated lines positioned 2 inches, 4 inches, 6 inches, and 10 inches from the second side edge; wherein the first and second sets of perforated lines extend along a full length of the liner; and wherein the width of the cable tray liner is 36 inches.

If the cable tray has, for example, a width of 16 inches and two side walls each having a height of 6 inches, the cable tray liner can be reconfigured to line the cable tray by tearing the perforated line positioned 4 inches from the first side edge, tearing the perforated line positioned 4 inches from the second side edge, folding the perforated line positioned 10 inches from the first side edge, and folding the perforated line positioned 10 inches from the second side edge.

If the cable tray has, for example, a width of 24 inches and two side walls each having a height of 2 inches, the cable tray liner can be reconfigured to line the cable tray by tearing the perforated line positioned 4 inches from the first side edge, tearing the perforated line positioned 4 inches from the second side edge, folding the perforated line positioned 6 inches from the first side edge, and folding the perforated line positioned 6 inches from the second side edge.

If the cable tray has, for example, a width of 24 inches and two side walls each having a height of 4 inches, the cable tray liner can be reconfigured to line the cable tray by tearing the perforated line positioned 2 inches from the first side edge, tearing the perforated line positioned 2 inches from the second side edge, folding the perforated line positioned 6 inches from the first side edge, and folding the perforated line positioned 6 inches from the second side edge.

If the cable tray has, for example, a width of 24 inches and two side walls each having a height of 6 inches, the cable tray liner can be reconfigured to line the cable tray by folding the perforated line positioned 6 inches from the first side edge, and folding the perforated line positioned 6 inches from the second side edge.

In another aspect, cable tray liners in accordance with the present disclosure may further include a guide having a plurality of colors aligned with sections between the perforated lines, the colors being associated with respective dimensions of a plurality of different cable tray.

In yet another aspect, cable tray liners disclosed herein may includes a thermoplastic, including for example polyvinyl chloride, polypropylene, polyethylene, or combinations thereof. In some examples, the thermoplastic may further includes a flame retardant, and have a UL94-HB or better flammability rating. In at least one example, the cable tray liner includes a Formex® GL material, a Formex® GS material, a Formex® GK material, a Formex® N3 material, a Formex® CND material, a Formex® EP material, and/or a Formex® TCI material, all sold by ITW Formex® of Carol Stream, IL.

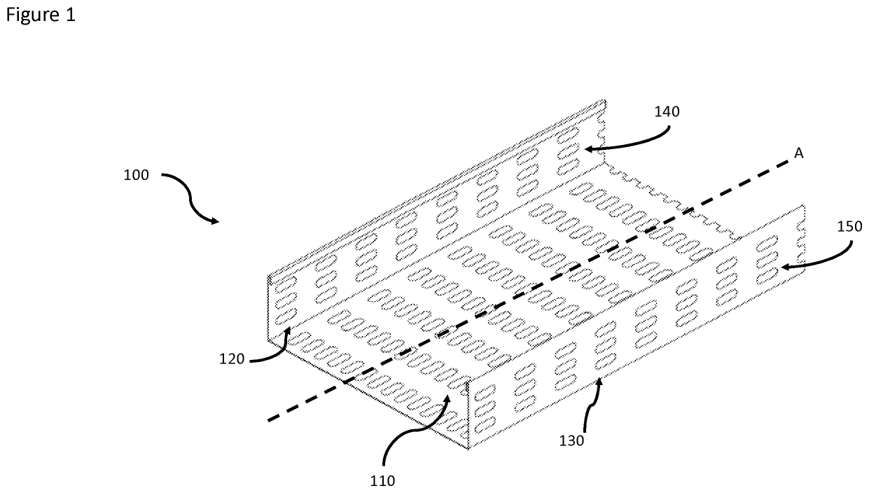

FIG. 1 shows an example cable tray 100. As shown, cable tray 100 includes a carrying base 110, wherein the carrying base 110 includes: a central longitudinal axis A; a first side 120 parallel to the central longitudinal axis A; a second side 130 opposite the first side 120 and parallel to the central longitudinal axis A; a width perpendicular to the central longitudinal axis A and defined by the distance between the first side 120 and the second side 130; and a length extending along the central longitudinal axis A. The cable tray further includes a first side wall 140 rising perpendicular from the first side 120, and a second side wall 150 rising perpendicular from the second side 130.

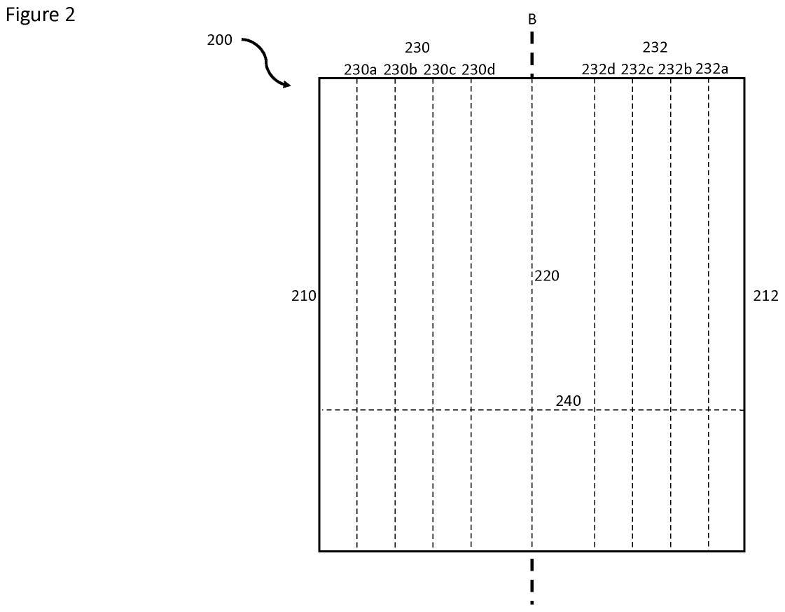

FIG. 2 shows an example cable tray liner 200 having a central longitudinal axis B; a first side edge 210 parallel to the central longitudinal axis B; a second side edge 212 opposite the first side edge 210 and parallel to the central longitudinal axis B; a first set 230 of one or more perforated lines (e.g., perforated lines 230a, 230b, 230c, and 230d) positioned between the central longitudinal axis B and the first side edge 210, wherein the first set 230 of perforated lines are parallel to the first side edge 210; and a second set 232 of two or more perforated lines (e.g., perforated lines 232a, 232b, 232c, and 232d) positioned between the central longitudinal axis B and the second side edge 212, wherein the second set 232 of perforated lines are parallel to the second side edge 212; and wherein the first 230 and second 232 sets of perforated lines extend along a full length of the cable tray liner 200. The cable tray liner 200 further includes a central perforated line 220 extending along the central longitudinal axis B, wherein the central perforated line 220 is parallel to the first 210 and second 212 side edges, and extends the full length of the cable tray liner 200. The cable tray liner 200 may further include one or more horizontal perforated lines 240, which are perpendicular to the central longitudinal axis B of the cable tray liner 200, and which extend the full width of the cable tray liner 200.

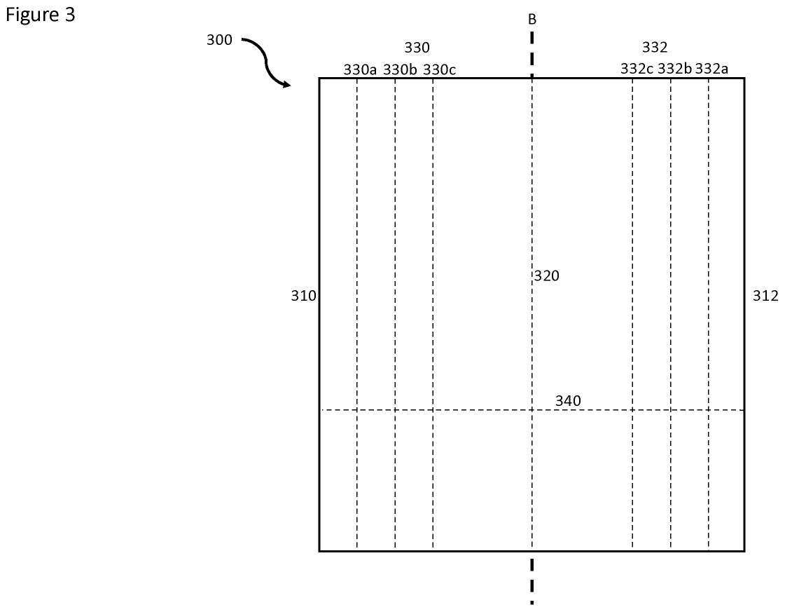

FIG. 3 illustrates another example cable tray liner 300. The cable tray liner 300 includes a central longitudinal axis B, a first side edge 310 parallel to the central longitudinal axis B, and a second side edge 312 opposite the first side edge 310 and parallel to the central longitudinal axis B. The cable tray liner 300 has a width perpendicular to the central longitudinal axis B and defined by the distance between the first side edge 310 and the second side edge 312.

The cable tray liner 300 of FIG. 3 includes a central perforated line 320 extending along the central longitudinal axis B along the full length of the liner 300. The liner 300 further includes a first set 330 of perforated lines and a second set 332 of perforated lines. The first set of perforated lines 330 includes three perforated lines positioned 2 inches (perforated line 330a), 4 inches (perforated line 330b), and 6 inches (perforated line 330c) from the first side edge 310. The second set 332 of perforated lines includes three perforated lines positioned 2 inches (perforated line 332a), 4 inches (perforated line 332b), and 6 inches (perforated line 332c) from the second side edge 312. The first set 330 of perforated lines and the second set 332 of perforated lines extend along a full length of the cable tray liner 300. The central perforated line 320 is equidistant from the first side edge 310 and the second side edge 312 (i.e., 12 inches from the first side edge 310 and 12 inches from the second side edge 312). An example width of the cable tray liner 300 is 24 inches, allowing multiple cable tray widths (e.g., 12 inches, 16 inches, 24 inches) and/or wall heights (e.g., 0 inches, 2 inches, 4 inches, 6 inches, etc.) to be lined using the cable tray liner 300.

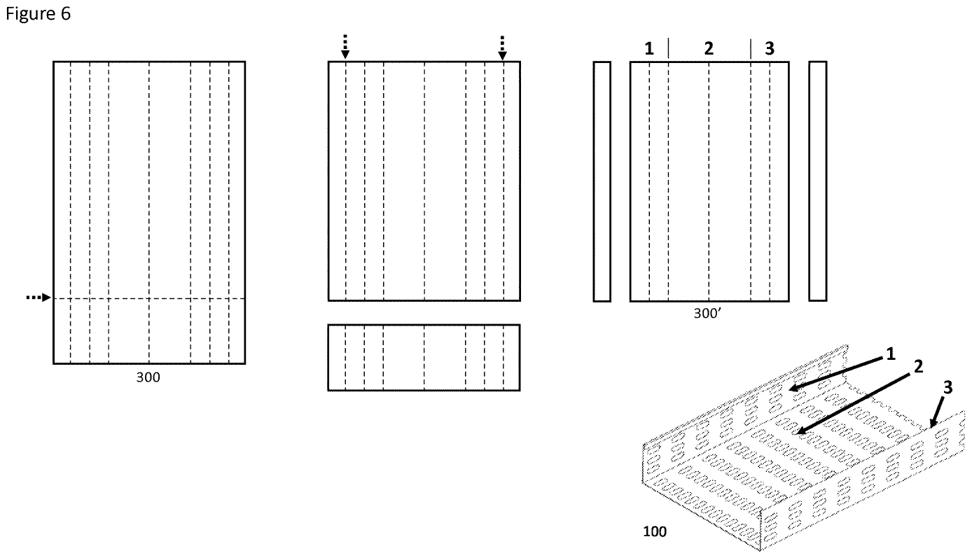

The example cable tray liner 300 of FIG. 3 can be reconfigured to be loaded into any number of different cable trays 100. In this example, any one or more of the first set 330 of perforated lines (i.e., perforated lines 330a, 330b, and 330c), any one or more of the second set 332 of perforated lines (i.e., perforated lines 332a, 332b, and 332c), any one or more horizontal lines 340, and the central perforated line 320, can be folded, torn, or left unaltered to match the dimensions of a given cable tray. FIG. 6 illustrates this process, showing how first tearing (indicated by dashed arrows) horizontal perforated line 340, and then tearing perforated lines 330a and 332a, will create a reconfigured cable tray liner 300′ having sections 1, 2, and 3, wherein section 1 is configured to cover the first side wall 140 of cable tray 100, section 3 is configured to cover the second side wall 150 of cable tray 100, and section 2 is configured to cover the carrying base 110 of cable tray 100. As demonstrated below, a number of different reconfigured cable tray liners can be created, employing a number of different combinations of tearing and/or folding of perforated lines.

To line a cable tray 100 having, for example, a width of 12 inches and no side walls 140 or 150, the cable tray liner 300 of FIG. 3 can be reconfigured to line that cable tray 100 by tearing the central perforated line 320.

To line a cable tray 100 having, for example, a width of 12 inches and two side walls 140 and 150 each having a height of 2 inches, the cable tray liner 300 of FIG. 3 can be reconfigured by tearing the perforated line 330b positioned 4 inches from the first side edge 210, tearing the perforated line 332b positioned 4 inches from the second side edge 312, folding the perforated line 330c positioned 6 inches from the first side edge 310, and folding the perforated line 332c positioned 6 inches from the second side edge 312. In this example, the section of the reconfigured cable tray liner 300 between perforated lines 330c and 332c cover the carrying base 110 of the cable tray 100, while the section of the reconfigured cable tray liner 300 between perforated lines 330c and 330b cover the first side wall 140, and the section between perforated lines 332c and 332b cover the second side wall 150.

To line a cable tray 100 having, for example, a width of 12 inches and two side walls 140 and 150 each having a height of 4 inches, the cable tray liner 300 of FIG. 3 can be reconfigured by tearing the perforated line 330a positioned 2 inches from the first side edge 310, tearing the perforated line 332a positioned 2 inches from the second side edge 312, folding the perforated line 330c positioned 6 inches from the first side edge 310, and folding the perforated line 332c positioned 6 inches from the second side edge 312. In this example, the section of the reconfigured cable tray liner 300 between perforated lines 330c and 332c cover the carrying base 110 of the cable tray 100, while the section of the reconfigured cable tray liner 300 between perforated lines 330c and 330a cover the first side wall 140, and the section between perforated lines 332c and 332a cover the second side wall 150.

To line a cable tray 100 having, for example, a width of 12 inches and two side walls 140 and 150 each having a height of 6 inches, the cable tray liner 300 of FIG. 3 can be reconfigured by folding the perforated line 330c positioned 6 inches from the first side edge 310, and folding the perforated line 332c positioned 6 inches from the second side edge 312. In this example, the section of the reconfigured cable tray liner 300 between perforated lines 330c and 332c cover the carrying base 110 of the cable tray 100, while the section of the reconfigured cable tray liner 300 between perforated line 330c and first side edge 310 cover the first side wall 140, and the section between perforated line 332c and second side edge 312 cover the second side wall 150.

To line a cable tray 100 having, for example, a width of 16 inches and no side walls, the cable tray liner 300 of FIG. 3 can be reconfigured by tearing the perforated line 330b positioned 4 inches from the first side edge 310, and tearing the perforated line 332b positioned 4 inches from the second side edge 312. In this example, the section of the reconfigured cable tray liner 300 between perforated lines 330b and 332b will cover or line the carrying base 110 of the cable tray 100.

To line a cable tray 100 having, for example, a width of 16 inches and two side walls 140 and 150 each having a height of 2 inches, the cable tray liner 300 of FIG. 3 can be reconfigured by tearing the perforated line 330a positioned 2 inches from the first side edge 310, tearing the perforated line 332a positioned 2 inches from the second side edge, folding the perforated line 330b positioned 4 inches from the first side edge 310, and folding the perforated line 332b positioned 4 inches from the second side edge 312. In this example, the section of the reconfigured cable tray liner 300 between perforated lines 330b and 332b will cover or line the carrying base 110 of the cable tray 100, while the section of the reconfigured cable tray liner 300 between perforated line 330c and 330b cover the first side wall 140, and the section between perforated lines 332c and 332b cover the second side wall 150.

To line a cable tray having, for example, a width of 16 inches and two side walls 140 and 150 each having a height of 4 inches, the cable tray liner 300 of FIG. 3 can be reconfigured by folding the perforated line 330b positioned 4 inches from the first side edge 310, and folding the perforated line 332b positioned 4 inches from the second side edge 312. In this example, the section of the reconfigured cable tray liner 300 between perforated lines 330b and 332b will cover or line the carrying base 110 of the cable tray 100, while the section of cable tray liner 300 between perforated line 330b and the first side edge 310 will cover the first side wall 140, and the section between perforated line 332b and the second side edge 312 will cover the second side wall 150.

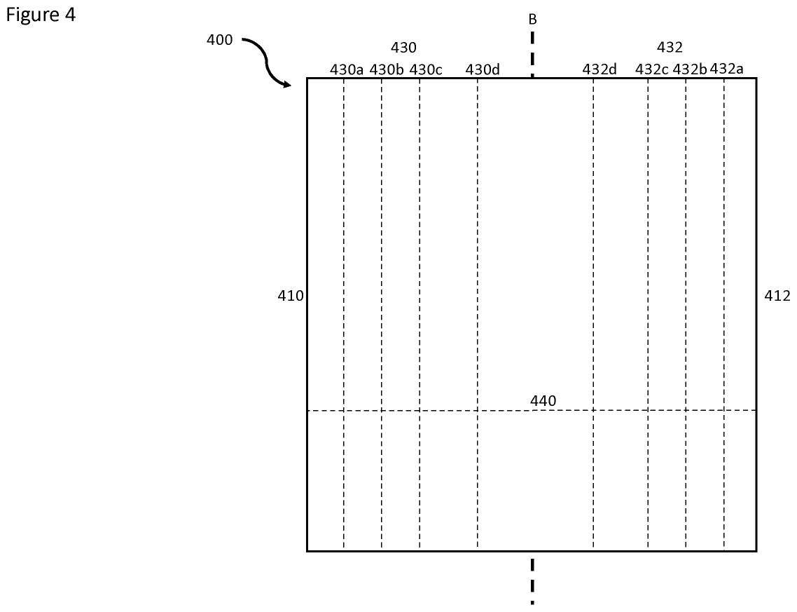

FIG. 4 sets forth another example cable tray liner 400. The example cable tray liner 400 includes a central longitudinal axis B, a first side edge 410 parallel to the central longitudinal axis B, and a second side edge 412 opposite the first side edge 410 and parallel to the central longitudinal axis B. The cable tray liner 400 has a width perpendicular to the central longitudinal axis B, which is defined by the distance between the first side edge 410 and the second side edge 412.

The example cable tray liner 400 includes a first set 430 of perforated lines on a first side of the axis B toward the first side edge 410. The first set of four perforated lines are positioned 2 inches (perforated line 430a), 4 inches (perforated line 430b), 6 inches (perforated line 430c), and 10 inches (perforated line 430d) from the first side edge 410. The second set 432 of perforated lines include four perforated lines positioned 2 inches (perforated line 432a), 4 inches (perforated line 432b), 6 inches (perforated line 432c), and 10 inches (perforated line 432d) from the second side edge 412. In the example of FIG. 4, the first set 430 of perforated lines and the second set 432 of perforated lines extend along a full length of the cable tray liner 400. An example width of the cable tray liner 400 is 36 inches, allowing multiple cable tray widths (e.g., 24 inches, 30 inches, 36 inches, etc.) and/or wall heights (e.g., 0 inches, 2 inches, 4 inches, 6 inches, etc.) to be lined using the cable tray liner 400.

To line a cable tray 100 having, for example, a width of 16 inches and two side walls 140 and 150 each having a height of 6 inches, the cable tray liner 400 of FIG. 4 can be reconfigured by tearing the perforated line 430b positioned 4 inches from the first side edge 410, tearing the perforated line 432b positioned 4 inches from the second side edge 412, folding the perforated line 430d positioned 10 inches from the first side edge 410, and folding the perforated line 432d positioned 10 inches from the second side edge 412.

To line a cable tray 100 having, for example, a width of 24 inches and two side walls 140 and 150 each having a height of 2 inches, the cable tray liner 200 of FIG. 4 can be reconfigured by tearing the perforated line 230b positioned 4 inches from the first side edge 210, tearing the perforated line 232b positioned 4 inches from the second side edge 212, folding the perforated line 230c positioned 6 inches from the first side edge 210, and folding the perforated line 232c positioned 6 inches from the second side edge 212.

To line a cable tray 100 having, for example, a width of 24 inches and two side walls 140 and 150 each having a height of 4 inches, the cable tray liner 400 of FIG. 4 can be reconfigured by tearing the perforated line 430a positioned 2 inches from the first side edge 410, tearing the perforated line 432a positioned 2 inches from the second side edge 412, folding the perforated line 430c positioned 6 inches from the first side edge 410, and folding the perforated line 432c positioned 6 inches from the second side edge 412.

To line a cable tray 100 having, for example, a width of 24 inches and two side walls 140 and 150 each having a height of 6 inches, the cable tray liner 400 of FIG. 4 can be reconfigured by folding the perforated line 430c positioned 6 inches from the first side edge 410, and folding the perforated line 432c positioned 6 inches from the second side edge 412.

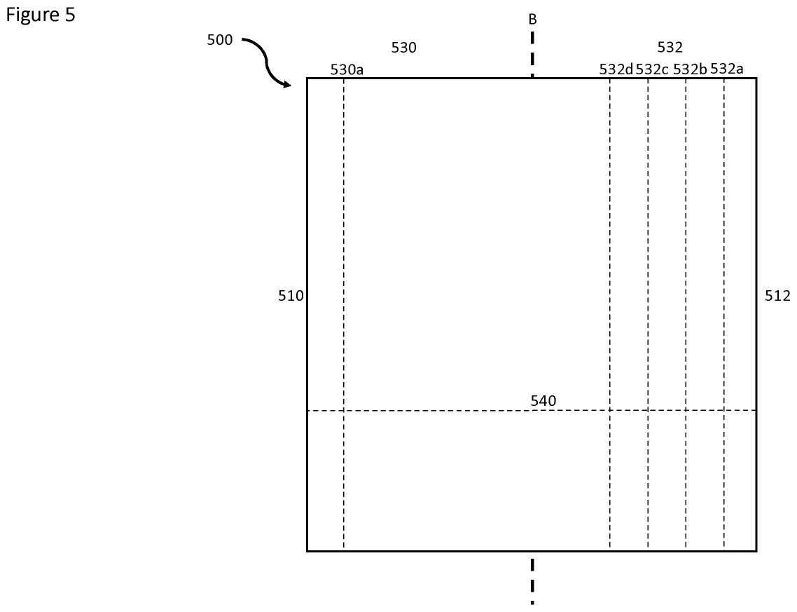

FIG. 5 sets forth another example cable tray liner 500. The example cable tray liner 500 includes a central longitudinal axis B; a first side edge 510 parallel to the central longitudinal axis B; and a second side edge 512 opposite the first side edge 510 and parallel to the central longitudinal axis B. The cable tray liner 500 has a width perpendicular to the central longitudinal axis B, and the width is defined by the distance between the first side edge 510 and the second side edge 512.

The cable tray liner 500 includes a first set 530 of one or more perforated lines on a first side of the axis B toward the first side edge 510. The first set 530 of perforated lines (e.g., one line 530a) are positioned every 2 inches (e.g., 2 inches from the first side edge 510 for perforated line 530a). The example cable tray liner 500 also includes a second set 532 of two or more perforated lines. The example second set 532 of perforated lines of FIG. 5 includes four perforated lines positioned 2 inches (perforated line 532a), 4 inches (perforated line 532b), 6 inches (perforated line 532c), and 8 inches (perforated line 532d) from the second side edge 512. The first set 530 and the second set 532 of perforated lines extend along a full length of the cable tray liner 500.

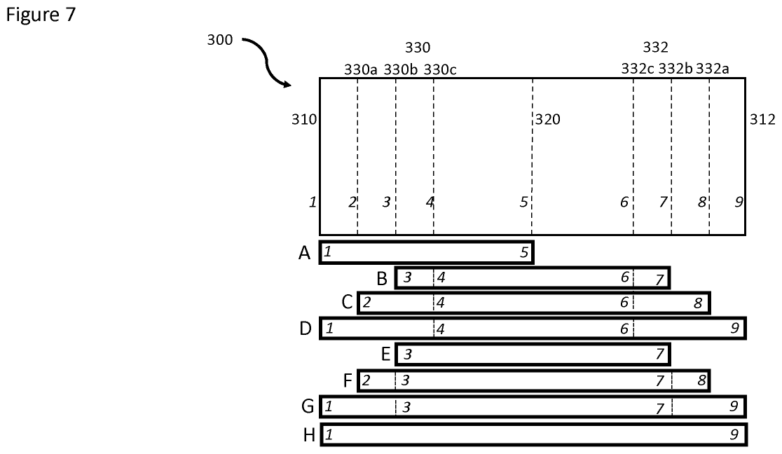

In another aspect, cable tray liners in accordance with the present disclosure may further include a guide system having one or more guides for directing the reconfiguration of a given liner to match the respective dimensions of a plurality of different cable trays. FIG. 7 illustrates an example guide system for reconfiguring the cable tray liner 300 of FIG. 3. As illustrated in FIG. 7, there are a total of 9 lines running the length of cable tray liner 300. To reconfigure cable tray 300, guides A-H can be used. For example, to line a cable tray 100 having a width of 12 inches and no side walls 140 or 150, guide A can be used (wherein the reconfigured liner spans the first side edge 310 and central perforated line 320).

To reconfigure cable tray 300 to line a cable tray 100 having, for example, a width of 12 inches and two side walls 140 and 150 each having a height of 2 inches, guide B can be used (wherein dashed lines designate perforated lines to be folded). Following guide B, perforated lines 330b and 332b are torn, and perforated lines 330c and 332c are folded.

To reconfigure cable tray 300 to line a cable tray 100 having, for example, a width of 12 inches and two side walls 140 and 150 each having a height of 4 inches, guide C can be used. Following guide C, perforated lines 330a and 332a are torn, while perforated lines 330c and 332b are folded.

To reconfigure cable tray 300 to line a cable tray 100 having, for example, a width of 12 inches and two side walls 140 and 150 each having a height of 6 inches, guide D can be used. Following guide D, perforated lines 330c and 332c are folded.

To reconfigure cable tray 300 to line a cable tray 100 having, for example, a width of 16 inches and no side walls, guide E can be used. Following guide E, perforated lines 330b and 332b are torn.

To reconfigure cable tray 300 to line a cable tray 100 having, for example, a width of 16 inches and two side walls 140 and 150 each having a height of 2 inches, guide F can be used. Following guide F, perforated lines 330a and 332a are torn, and perforated lines 330b and 332b are folded.

To reconfigure cable tray 300 to line a cable tray having, for example, a width of 16 inches and two side walls 140 and 150 each having a height of 4 inches, guide G can be used. Following guide G, perforated lines 330b and 332b are folded.

To reconfigure cable tray 300 to line a cable tray having, for example, a width of 24 inches and no side walls, guide H can be used. Following guide H, cable tray liner 300 is used in original state.

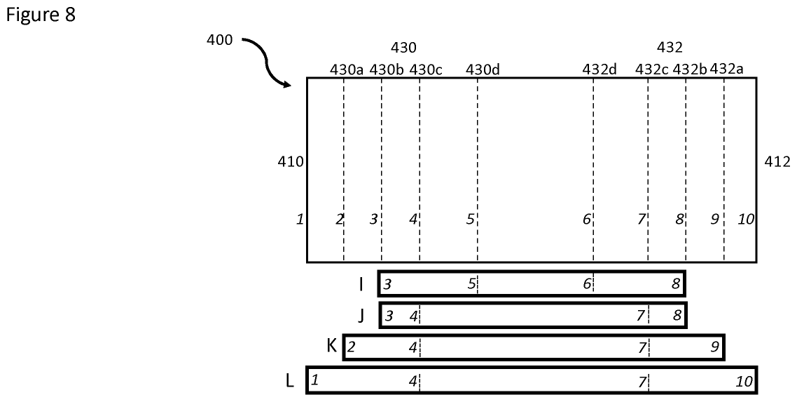

FIG. 8 illustrates an example guide system for reconfiguring the cable tray liner 400 of FIG. 4. As illustrated in FIG. 8, there are a total of 10 lines running the length of cable tray liner 400. To reconfigure cable tray 400, guides I-L can be used. For example, to reconfigure cable tray liner 400 to line a cable tray 100 having a width of 16 inches and two side walls 140 and 150 each having a height of 6 inches, guide I can be used (wherein dashed lines designate perforated lines to be folded). Following guide I, perforated lines 430b and 432b are torn, and perforated lines 430d and 432d are folded.

To reconfigure cable tray liner 400 to line a cable tray 100 having, for example, a width of 24 inches and two side walls 140 and 150 each having a height of 2 inches, guide J can be used (wherein dashed lines designate perforated lines to be folded). Following guide J, perforated lines 430b and 432b are torn, and perforated lines 430c and 432c are folded

To reconfigure cable tray liner 400 to line a cable tray 100 having, for example, a width of 24 inches and two side walls 140 and 150 each having a height of 4 inches, guide K can be used (wherein dashed lines designate perforated lines to be folded). Following guide K, perforated lines 430a and 432a are torn, and perforated lines 430c and 432c are folded.

To reconfigure cable tray liner 400 to line a cable tray 100 having, for example, a width of 24 inches and two side walls 140 and 150 each having a height of 6 inches, guide L can be used (wherein dashed lines designate perforated lines to be folded). Following guide L, perforated lines 430c and 432c are folded.

In some examples, the guides A-H of FIG. 7 or the guides I-L of FIG. 8 may be combined into a single sheet of material, such as a sheet having a same width as the corresponding cable tray liner and having the guides A-H or I-L printed onto the sheet. In some examples, the guides A-H or I-L are color coded with different colors, which are aligned with sections between the perforated lines. Each of the colors is associated with the respective dimensions of different cable trays (e.g., different widths and/or wall heights). Additionally or alternatively, the guides (e.g., colors) may be printed or otherwise included directly on the configurable cable tray liner. By determining the color corresponding to the cable tray dimensions and matching to the color printed on the cable tray liner, the user can identify the appropriate perforated lines to fold and/or tear to obtain the configured cable tray liner dimensions.

While the examples disclosed above include example numbers, spacings, and balance of perforated lines, other examples may include additional perforated lines, fewer perforated lines, lines spaced at different intervals, and/or any other configuration of the perforated lines to fit cable trays having multiple widths and/or wall heights using a configurable tray liner.

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A cable tray liner, comprising:
a central longitudinal axis;
a first side edge parallel to the central longitudinal axis;
a second side edge opposite the first side edge and parallel to the central longitudinal axis;
a first set of one or more perforated lines positioned between the central longitudinal axis and the first side edge, wherein the first set of perforated lines are parallel to the first side edge; and
a second set of two or more perforated lines positioned between the central longitudinal axis and the second side edge, wherein the second set of perforated lines are parallel to the second side edge;
wherein the first and second sets of perforated lines extend along a full length of the cable tray liner.

2. The cable tray liner of claim 1, wherein the first and second sets of perforated lines are foldable, tearable, or both.

3. The cable tray liner of claim 1, further comprising a central perforated line extending along the central longitudinal axis along the full length of the cable tray liner.

4. The cable tray liner of claim 1, wherein the cable tray liner has a width perpendicular to the central longitudinal axis and defined by the distance between the first side edge and the second side edge, wherein the width is 24 inches or 36 inches.

5. The cable tray liner of claim 1, wherein the liner is provided in the form of a roll or sheet.

6. The cable tray liner of claim 1, wherein the first set of perforated lines include one or more perforated lines positioned every 2 inches from the first side edge, and wherein the second set of perforated lines include two or more perforated lines positioned every 2 inches from the second side edge.

7. The cable tray liner of claim 1, wherein the cable tray liner includes a thermoplastic.

8. The cable tray liner of claim 7, wherein the thermoplastic includes a flame retardant.

9. The cable tray liner of claim 1, wherein the cable tray liner includes a Formex® GL material, a Formex® GS material, a Formex® GK material, a Formex® N3 material, a Formex® CND material, a Formex® EP material, or a Formex® TCI material.

10. The cable tray liner of claim 1, wherein the cable tray liner includes a material having a UL94-HB or better flammability rating.

11. The cable tray liner of claim 1, further comprising a guide comprising a plurality of colors aligned with sections between the perforated lines, the colors being associated with respective dimensions of a plurality of different cable trays.

12. A cable tray system comprising:
a cable tray having a width and a length; and
a cable tray liner comprising:
a central longitudinal axis such that, when installed, the central longitudinal axis extends along the length of the cable tray;
a first side edge parallel to the central longitudinal axis;
a second side edge opposite the first side edge and parallel to the central longitudinal axis;
a first set of one or more perforated lines positioned between the central longitudinal axis and the first side edge, wherein the first set of perforated lines are parallel to the first side edge; and
a second set of two or more perforated lines positioned between the central longitudinal axis and the second side edge, wherein the second set of perforated lines are parallel to the second side edge;
wherein the first and second sets of perforated lines extend along a full length of the cable tray liner.

13. The cable tray system of claim 12, wherein the first and second sets of perforated lines are foldable, tearable, or both.

14. The cable tray system of claim 12, further comprising a central perforated line extending along the central longitudinal axis along the full length of the cable tray liner.

15. The cable tray system of claim 12, wherein the cable tray liner has a width perpendicular to the central longitudinal axis and defined by the distance between the first side edge and the second side edge, wherein the width is 24 inches or 36 inches.

16. The cable tray system of claim 12, wherein the cable tray liner includes a thermoplastic.

17. The cable tray system of claim 16, wherein the thermoplastic includes a flame retardant.

18. The cable tray system of claim 12, wherein the cable tray liner includes a Formex® GL material, a Formex® GS material, a Formex® GK material, a Formex® N3 material, a Formex® CND material, or a Formex® TCI material.

19. The cable tray system of claim 12, wherein the cable tray liner further includes at least one horizontal perforated line perpendicular to the central longitudinal axis of the cable tray liner, and which extend the full width of the cable tray liner.

20. The cable tray system of claim 19, wherein the cable tray liner is provided in the form of a roll or sheet.
